(19) United States
(12) Patent Application Publication
(10) Pub. No.: US 2026/0057424 A1
(43) Pub. Date: Feb. 26, 2026

(54) SYSTEM AND METHOD FOR PROCESSING UTILITY BILLS

(71) Applicant: Honeywell International Inc., Charlotte, NC (US)

(72) Inventors: Manojsingh Dobwal, PUNE (IN); Harish H S, Bangalore (IN); Devodyuti Mukherjee, Kolkata (IN); Jayanth Thyagarajan, Tiruchirappalli (IN); Sambeet Das, Bhubaneswar (IN)

(21) Appl. No.: 18/809,520

(22) Filed: Aug. 20, 2024

(51) Int. Cl. G06Q 30/04; G06Q 50/06

(52) U.S. Cl. CPC G06Q 30/04; G06Q 50/06

(57) ABSTRACT

A system for processing utility bills having distinct formats is provided. The system comprises at least one processor. The processor obtains a plurality of utility bills comprising at least two utility bills of distinct formats and generates bill data based on the plurality of utility bills. The bill data includes a plurality of fields and corresponding field values for each bill. The processor classifies the field values into a set of predetermined uniform categories based on a field-category mapping to obtain uniform classified data. The processor computes one or more utility metrics for each utility bill. The processor generates utility reports for the utility bills based on the uniform classified data and the utility metrics, where each is of a predefined standard template and includes the utility metrics and uniform classified data. The processor provides the utility reports in the predefined standard template for display on a user interface.

### TECHNICAL FIELD OF THE INVENTION

The present subject matter relates to data processing systems and, more particularly, to systems and methods for processing utility bills.

### BACKGROUND OF THE INVENTION

In today's utility sector, the processing of utility bills is an important operational task that involves managing and interpreting a varied range of billing formats and data types from various service providers. Utility bills contain essential information such as consumption metrics, billing periods, and cost details, and recording and managing this data is an important operation for enterprises.

The utility bills vary widely in their presentation format and terminology, making it difficult to establish uniform processes for data extraction and interpretation. Conventional approaches that rely on manual entry and human interpretation are not only time-consuming but also susceptible to errors, especially when handling large volumes of bills. These manual methods often result in inconsistencies and delays in processing, impacting operational efficiency and data accuracy.

### SUMMARY OF THE INVENTION

The present subject matter provides systems and methods for processing utility bills having distinct formats.

In an embodiment, a system for processing utility bills having distinct formats is disclosed. The system comprises a storage and at least one processor coupled to the storage. The processor is configured to obtain a plurality of utility bills comprising at least two utility bills of distinct formats and generate bill data based on the plurality of utility bills. The bill data includes a plurality of fields and corresponding field values for each bill. The processor is further configured to classify the field values into a set of predetermined uniform categories based on a field-category mapping to obtain uniform classified data. Further, the processor is configured to compute one or more utility metrics for each utility bill based on the bill data. Yet further, the processor is configured to generate utility reports for the utility bills based on the uniform classified data and the utility metrics, where each is of a predefined standard template and includes the utility metrics and uniform classified data. The processor is further configured to provide the utility reports in the predefined standard template for display on a user interface.

In some embodiments, the processor is further configured to identify a trained model for processing the utility bills and provide the bill data to the trained model. The trained model detects the plurality of fields in the utility bill, determines one or more predetermined uniform categories corresponding to the detected plurality of fields based on the field-category mapping, and classifies the plurality of field values corresponding to the plurality of fields into the one or more predetermined uniform categories. The processor is further configured to receive the uniform classified data as an output from the trained model. The uniform classified data includes the classified plurality of field values and the corresponding one or more predetermined uniform categories.

In some embodiments, for generating the bill data, the processor is configured to obtain the plurality of bills from storage using a storage path, process each utility bill to identify and extract the fields and corresponding field values, and store the fields, field values, and utility bill ID as bill data in the storage.

In some embodiments, the processor converts the fields and field values into a default language selected for the utility report.

In some embodiments, the processor is configured to display a list of predefined standard templates on the display, receive a user selection of a new predefined standard template, update the utility reports according to the new template, and provide the updated reports for display on the user interface.

In some embodiments, the processor may receive a user request to create a new template for the utility reports by displaying a customizable interface with uniform categories and utility bill metrics. The processor may receive one or more user selections of categories and metrics, and accordingly create a custom template based on user selections, which is then stored in the storage.

In some embodiments, the processor may display a list of utility metrics, receive user selections of the utility metrics, and compute the selected metrics based on the bill data.

In another embodiment, a method for processing utility bills having distinct formats is disclosed. The method comprises obtaining, by a processor, a plurality of utility bills comprising at least two utility bills of distinct formats. The method further comprises generating bill data based on the plurality of utility bills. The bill data includes a plurality of fields and a plurality of corresponding field values for each of the plurality of bills. The method further comprises classifying, for each of the plurality of bills based on the bill data and a field-category mapping, the plurality of field values into a set of predetermined uniform categories to obtain uniform classified data. The field-category mapping includes the plurality of fields in a mapped relationship with the set of predetermined uniform categories. The method further comprises computing, for each of the plurality of utility bills, one or more utility metrics based on the bill data. The method further comprises generating a plurality of utility reports corresponding to the plurality of utility bills based on the uniform classified data and the one or more utility metrics. Each of the plurality of utility reports is as per a predefined standard template and each utility report includes the one or more utility metrics and the uniform classified data for the corresponding utility bill in the predefined standard template. The method further comprises providing the plurality of utility reports in the predefined standard template for displaying on a user interface of a display.

In yet another embodiment, a computer-readable medium having computer-executable instructions stored thereon is disclosed. The computer-executable instructions, when executed by a processing system, cause the processing system to obtain a plurality of utility bills including at least two utility bills of distinct format. Further, the computer-executable instructions cause the processing system to generate bill data based on the plurality of utility bills. The bill data comprises a plurality of fields and a plurality of corresponding field values for each of the plurality of bills. Further, the computer-executable instructions cause the processing system to classify, for each of the plurality of bills based on the bill data and a field-category mapping, the plurality of field values into a set of predetermined uniform categories to obtain uniform classified data. The field-category mapping comprises the plurality of fields in a mapped relationship with the set of predetermined uniform categories. Further, the computer-executable instructions cause the processing system to compute, for each of the plurality of utility bills, one or more utility metrics based on the bill data. Further, the computer-executable instructions cause the processing system to generate a plurality of utility reports corresponding to the plurality of utility bills based on the uniform classified data and the one or more utility metrics, wherein each of the plurality of utility reports is as per a predefined standard template, and wherein each of the plurality of utility reports comprises the one or more utility metrics and the uniform classified data for the corresponding utility bill in the predefined standard template. Further, the computer-executable instructions cause the processing system to provide the plurality of utility reports in the predefined standard template for displaying on a user interface of a display.

The present subject matter provides systems and methods for processing utility bills, which can handle distinct formats, classify data uniformly, compute utility metrics, and generate standardized reports. The proposed solutions enable the rapid onboarding of customers by allowing the system to analyze and extract various components from the bills, such as Time of Use (TOU) rates and slab rates. It supports bulk uploads, significantly saving time and reducing the risk of human error associated with manual data entry. This comprehensive automation not only enhances operational efficiency but also improves the overall user experience.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates an environment implementing a system for processing utility bills having distinct formats, according to one or more embodiments of the present disclosure;

FIG. 2 is a schematic block diagram illustrating one or more components of the system, according to one or more embodiments of the present disclosure;

FIG. 3 illustrates a schematic block diagram illustrating the operations of the system, according to one or more embodiments of the present disclosure;

FIG. 4 illustrates a flowchart of a method of processing utility bills having distinct formats, according to one or more embodiments of the present disclosure;

FIG. 5 illustrates a flowchart of a method of classifying a plurality of field values of a utility bill into a set of predetermined uniform categories, according to one or more embodiments of the present disclosure;

FIG. 6 illustrates a flowchart of a method of generating bill data corresponding to a plurality of utility bills, according to one or more embodiments of the present disclosure;

FIG. 7 illustrates a flowchart of a method of updating a plurality of utility reports as per a template selected by a user, according to one or more embodiments of the present disclosure;

FIG. 8 illustrates a flowchart of a method of creating a new template for utility reports, according to one or more embodiments of the present disclosure; and

FIG. 9 illustrates a flowchart of a method of selecting utility metrics for utility reports, according to one or more embodiments of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

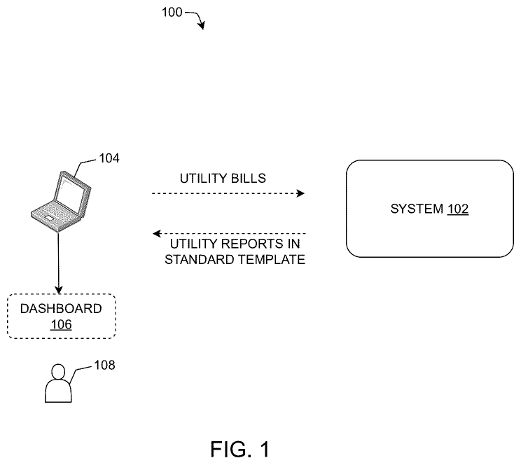

FIG. 1 illustrates an environment 100 implementing a system 102 for processing utility bills having distinct formats, according to one or more embodiments of the present disclosure. Examples of the utility bills include, but are not limited to, electricity bills, gas bills, water consumption bills, etc. In some embodiments, the system 102 may be implemented in enterprises, organizations, institutions, etc, for managing and processing utility bills of distinct format. Herein, the system 102 may be implemented locally at a site of an enterprise or remotely in some implementations. In some embodiments, the system 102 may be implemented by a service provider providing utility management services. Herein, the system 102 may be implemented as a cloud server and/or a cloud service and/or as per a Software as a Service (SaaS) model. In said embodiments, subscription or license to the services offered by the service provider may be taken by enterprises, organizations, institutions, etc., for managing utility bills thereof. As would be appreciated, the system 102 may be implemented in any one of or a combination of the aforementioned implementation techniques for processing utility bills of distinct formats.

According to aspects of the present disclosure, the system 102 is configured to take as input a plurality of utility bills having at least two utility bills of distinct formats and provide information and utility metrics related to the plurality of utility bills uniformly, i.e., in a standard template, for displaying on a display to a user, such as an admin personnel. Without limitation, the term template as used herein may be understood as a structure or a layout for presenting information associated with a utility bill. In some implementations, the template may be a standard template, i.e., the various sections, sub-sections, and categories within the template may be predetermined and static. In some implementations, the template may be customizable, i.e., one or more of the sections, sub-sections, and the categories may be editable/user-selectable, as would be explained in detail with regard to other figures. The information associated with a utility bill may be understood as various fields and corresponding field values which are present in the utility bill. As an example, for an electricity bill, the various fields and corresponding field values may be: “Account Number: 123456789,” “Billing Period: June 1, 2024-June 30, 2024,” “Previous Reading: 1500 kWh,” “Current Reading: 1800 kWh,” “Usage: 300 kWh,” “Rate per kWh: INR 4,” “Total Charges: INR 10000,” “Due Date: July 15, 2024,” “Payment Received: INR 5000,” and “Balance Due: INR 5000.”

In some embodiments, the system 102 may receive the plurality of utility bills from a user device 104, such as a laptop, a desktop, a remote computer, a tablet, or a smartphone. In some examples, the user device 104 may be a user device of the admin personnel who is entrusted with the management of the utility bills. The admin personnel may accordingly input the plurality of utility bills say, for example, using a client application running on the user device 104. Herein, the action of inputting the utility bills may include, uploading the utility bills to the system 102 using the client application user device 104. The client application may be a dedicated application or may be a web application. As may be understood, one or more admin personnel may perform the inputting of the plurality of utility bills using respective user devices 104. However, for the sake of brevity, only one user device 104 is illustrated.

In a further example of distributed inputting, the system 102 may be implemented in an enterprise where a plurality of user devices, such as the user device 104, may be assigned to a plurality of employees of the enterprise. Each of the user devices may have a corresponding client application running thereon. An employee may use the client application on his user device to upload one or more utility bills associated with him to the system 102. The system 102 may accordingly receive a large set of utility bills from the employees of the enterprise and the set of utility bills may include one or more utility bills of distinct formats. For instance, a first employee may be residing at a location A which is serviced by an electricity company A, while a second employee may be residing at a location B which is serviced by an electricity company B. Accordingly, in an example, the formatting of the utility bill of the first employee may be distinct than the formatting of the utility bill of the second employee. In other words, the utility bill of the first employee is distinct than the utility bill of the second employee.

In some embodiments, the system 102 may be configured to perform one or more operations on the received utility bills to generate a plurality of utility reports corresponding to the plurality of utility bills. As mentioned above, each of the plurality of utility reports is as per a predefined standard template, i.e., incudes information pertaining to the plurality of utility bills in a uniform way for presenting to the user. The utility reports in the predetermined standard template are subsequently provided to the user device 104. In some examples, the utility reports may be presented on a dashboard 106 that may be running on the client application on the user device 104 or may be a separate application on the user device 104. The dashboard 106 displays the utility reports on a display of the user device 104 to a user 108.

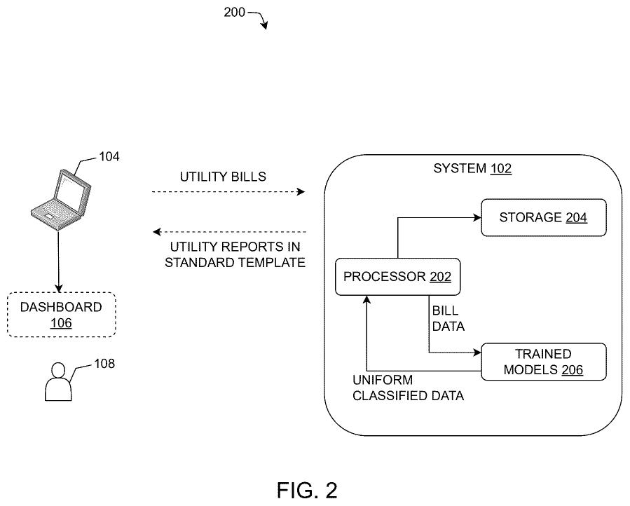

FIG. 2 illustrates a schematic block diagram 200 illustrating one or more components of the system 102, according to one or more embodiments of the present disclosure. As shown in the figure, the system 102 may include a processor 202, storage 204, and trained model 206.

The processor 202, in some examples, may be implemented or realized as general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In some examples, the processor 202 may be realized as microprocessors, controllers, microcontrollers, or state machines. In some examples, the processor 202 may be realized as a combination of computing devices, such as, a combination of digital signal processors and microprocessors, a plurality of microprocessors, one or more microprocessors in conjunction with a digital signal processor core, or any other such combination/configuration.

The storage 204 comprises one or more non-transitory computer-readable storage media, including but not limited to volatile storage media such as random-access memory (RAM), registers, cache, etc., as well as non-volatile storage media such as read-only memory (ROM), hard disk drives, solid-state drives, flash memory, optical storage devices, and so forth. Furthermore, the storage 204 may encompass computer-readable storage media that are distributed across a plurality of physical computing devices connected via a network, such as storage clusters within public, private, or hybrid cloud-based environments. In some embodiments, the storage 204 may be provisioned with software components that facilitate the system 102 in executing functionalities disclosed herein. These software components typically consist of program instructions executable by the processor 202, organized into software applications, virtual machines, software development kits, toolsets, or similar structures. Furthermore, the storage 204 may be configured to maintain data within one or more databases, file systems, or equivalent data structures. The storage 204 may also be implemented in other forms and/or configured to store data using alternative methods. In some examples, the storage 204 may include a field-category mapping. The field category mapping includes a mapping between a plurality of uniform categories that are defined as per a standardized nomenclature of the system 102 and a plurality of field names of fields as used by different service providers. As may be understood, different field category mappings for different utility service type may be stored in the storage 204.

The trained model(s) 206 (or “the model 206”) may be understood as a machine learning model developed through a training process utilizing training data including, but not limited to, utility bills of different utility services and of distinct formats, field names, field values, uniform categories, utility metrics. Herein, the model 206 may be trained for determining uniform categories corresponding to fields included in a utility bill. Furthermore, the trained model 206 may be configured to classify the field values of the fields in the uniform categories, thus determined. As may be understood, one or more trained models 206 may be provided in the system 206. Based on the utility service type of the plurality of bills being processed, the appropriate trained model 206 may be selected by the processor 202. In some examples, the trained models 206 may also include one or more trained models that are further customized for one or more enterprises. Herein, one or more customizations may be requested by the enterprises. Accordingly, a base version of the trained model may be customized as per the required customizations of an enterprise and stored in the storage. Although shown outside to the storage 204, the trained models 206 may be stored in the storage 204, in some examples.

In operation, the user 108 seeking to process a plurality of utility bills having at least two utility bills of distinct format may upload the plurality of utility bills to the system 102 using the user device 104. The user 108 may perform the uploading of the utility bills through the dashboard 106, in an example. The dashboard 106 may provide an option, such as a button, for uploading the utility bills to the system 102. In an example, the dashboard may be a standalone application or a sub-program in a standalone application. In another example, the dashboard may be provided in a webpage running in a web browser application of the user device 104.

In some examples, a different interface of the application (or the web application) may be used for uploading the utility bills to the system 102. For instance, a separate interface may be used for uploading the utility bills and the dashboard may be used as a last interface for displaying the utility reports. In some examples, the utility bills may be provided to the system 102 through other means, say, using email communication. The utility bills received from the user device 104 are stored in the storage 204 by the system 102.

In some embodiments, the processor 202 may be configured to process the plurality of utility bills to generate corresponding utility reports that provide a uniform representation of the information included in the utility bills to an end user. For instance, the processor 202 may be configured to receive a bill processing request from the user device 104. The bill processing request may include a storage path indicating the location of the plurality of utility bills that are to be processed. In some embodiments, the bill processing request may also include information about the trained model that is to be used for processing the utility bills. For instance, an enterprise may have a customized trained model 206 stored in the storage 204 of the system 102.

Based on the storage path included in the bill processing request, the processor 202 may be configured to obtain the plurality of utility bills including the at least two utility bills of distinct format from the storage 204. As may be understood, each of the utility bills may be a digital file, such as a PDF file. Furthermore, one or more utility bills may be in a language, say, Hindi language, which is different than a default language, say, English, of the system 102.

In some embodiments, the processor 202 may be configured to implement one or more character recognition techniques, such as an OCR technique, for digitizing and reading the text from the plurality of utility bills. Furthermore, in cases where the language is not the default language, the processor 202 may apply a language translation technique for converting such utility bills in the default language of the system 102. On application of the aforementioned techniques, as required, the processor 202 may extract a plurality of fields and a plurality of field values corresponding to the fields for each utility bill of the plurality of utility bills. This extracted information is stored along with a bill ID of the bill, as bill data in the storage 204. Thus, the bill data includes, for each of the plurality of utility bills, a bill ID, a plurality of fields included in the utility bill, and a plurality of field values corresponding to the fields.

In some embodiments, the processor 202 may utilize the service of the trained models 206 for performing one or more operations associated with the processing of the utility bills. For instance, after the generation of the bill data, the processor 202 may be configured to uniformly represent the fields included in the plurality of utility bills. Herein, the processor 202 may perform a classification operation by utilizing the trained models 206. In the classification operation, for each utility bill, the uniform categories corresponding to the fields included in the utility bill are first determined. Thereafter, the field values are classified into the uniform categories, thus determined. The field values classified in the uniform categories are stored as uniform classified data in the storage 204 and is mapped against the bill ID of the utility bill. In an example, the processor 202 performs the classification operation as explained above using the trained model 206, which may be identified based on the utility service type of the utility bill or the bill processing request or both.

After the classification, the processor 202 may compute one or more utility metrics for each of the utility bills based on corresponding bill data. The utility metric may provide insights into consumption patterns of the utility over defined periods, in one example. In another example, the utility metrics may include a detailed breakdown of a component. For example, for an electricity bill, the utility metrics may include a detailed breakdown of energy consumption.

According to aspects of the present disclosure, the processor 202 may be configured to generate a plurality of utility reports corresponding to the plurality of utility bills based on the uniform classified data and the one or more utility metrics. Herein, each of the plurality of utility reports may be in a predefined standard template. Further, each of the plurality of utility reports may include the one or more utility metrics and the uniform classified data for the corresponding utility bill in the predefined standard template. In some embodiments, the plurality of utility reports is presented on the dashboard 106 of the user device 104.

The utility reports may be understood to include uniform representation of fields and metrics in a uniform format. As a result, the user 108 is able to easily comprehend the utility service consumption. Furthermore, the requirement to understand distinct formats of the utility bills is averted.

In some embodiments, the system 102 may be adaptable and may provide the user 108 with options to select different formats of the utility reports. Herein, the processor 202 may be configured to display a list of predefined standard templates on the display and receive a user selection of a new predefined standard template from the list. As may be understood, the new predefined standard template is distinct from the predefined standard template originally used to generate the plurality of utility reports. Upon receiving the user selection, the processor 202 may update the plurality of utility reports according to the new predefined standard template and provides the updated reports for display on the user interface of the dashboard 106. For example, a user may initially have utility reports generated in Template A, where the outstanding bill amount is presented on the second page. The user may select Template B from the list, which displays the outstanding bill amount on the first page. The processor 202 updates the utility reports to conform to Template B, and the updated reports are then displayed accordingly.

In some embodiments, the system 102 may provide the user 108 with the ability to create custom templates for utility reports. Herein, the processor 202 may be configured to receive a user request for creating a new template and display a customizable interface on the display. The customizable interface may comprise a set of predetermined uniform categories and a set of utility metrics. The processor 202 may receive a user selection of one or more predetermined uniform categories and one or more utility metrics through the customizable interface. Based on the user selection, the processor 202 may create the custom template and store it in the storage 204, allowing the user to generate utility reports that are tailored to specific preferences and requirements. For instance, a user may wish to create a template that includes specific categories such as “Total Energy Consumption” and “Cost Breakdown by Month.” The user selects these categories and metrics through the interface, and the processor 202 creates and stores the custom template. Subsequently, the user can generate utility reports that align with this custom template.

In some embodiments, the system 102 may enhance the user's ability to select relevant utility metrics for inclusion in the utility reports. The processor 202 may be configured to display a list of utility metrics on the display and receive a user selection of one or more utility metrics from the list. The selected utility metrics may be used for computing the necessary data during the processing of utility bills. Upon receiving the user selection, the processor 202 may select the one or more utility metrics for computing and include the computed metrics in the generated utility reports, ensuring that the reports provide insights that are most pertinent to the user's needs. For example, an enterprise user may want to analyze “Peak Usage Hours” and “Monthly Consumption Trends.” The user selects these metrics from the list, and the processor 202 calculates and includes these metrics in the utility reports, providing the user with detailed insights into their utility usage patterns.

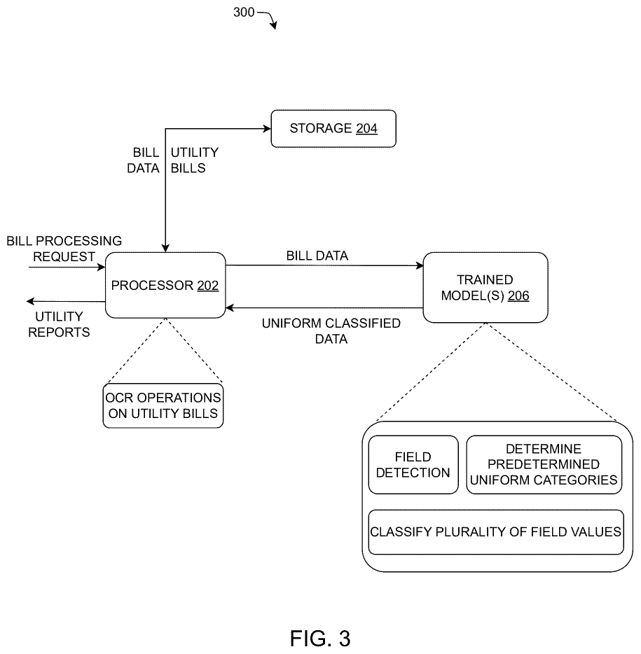

FIG. 3 illustrates a schematic block diagram 300 illustrating operations of one or more components of the system 102, according to one or more embodiments of the present disclosure.

As described previously in the detailed description, the processor 202 may be configured to generate bill data from the plurality of utility bills. Herein, initially, the user 108 may upload the plurality of utility bills to the system 102 using the user device 104. In some examples, the utility bills may be in various digital formats such as PDF, JPEG, or other document types. Furthermore, in some examples, one or more of the utility bills may be in different languages and layouts based on the service providers and regions. In an example, the utility bills are stored in the storage 204.

In an example, the processor 202 may accesses the utility bills stored in the storage 204 and may perform the bill data generation process. Herein, the processor 202 may implement an optical character recognition (OCR) techniques to digitize and extract text from the utility bills. Herein, in an example, the processor 202 may scan the uploaded documents to identify and convert printed or handwritten text into machine-readable data. For example, if a utility bill contains details such as “Usage: 500 kWh,” “Period: June 2024,” and “Amount: $100,” the OCR process implemented by the processor 202 helps in extracting this text data for further processing. In some examples, as required, the processor 202 may also employ one or more language translation techniques if the utility bills are in a language different from the default language of the system 102. This ensures that all extracted text is standardized into a common language.

Once the text data is extracted and, if necessary, translated, the processor 202 may identify and extract a plurality of fields and corresponding field values from each utility bill. This involves recognizing information, such as usage amounts, billing periods, service types, and costs in the utility bills. The extracted data for each bill is organized into a structured format, typically including a bill ID, a list of fields, and their associated values. For instance, a bill may have the following structured data: Bill ID: 12345, Fields: [“Energy Usage,” “Billing Period,” “Amount Due”], and Values: [“500 kWh,” “June 2024,” “INR 100”]. The extracted information is stored as bill data in the storage 204.

As mentioned previously in the detailed description, the processor 202 may be configured to classify the plurality of field values into a set of predetermined uniform categories to obtain uniform classified data. The processor 202 may perform this classification operations by, first, identifying the trained model 206 that is suitable for processing the specific types of utility bills provided. As may be understood, different trained models may be optimized for different utility services such as electricity, water, or gas. In an example, the processor 202 may determine the trained model based on a utility service type of the utility bills being processed.

Once the appropriate trained model 206 is identified, the processor 202 may provide the bill data as input to the trained model 206. The bill data includes various details extracted from the utility bills, such as usage amounts, billing periods, and costs, which are initially in diverse formats depending on the service providers. The trained model 206 processes this input data through one or more steps to achieve a standardized classification. For instance, in a first step, the trained model 206 may identify the plurality of fields present in each of the utility bills. For example, the model may recognize fields such as “Total Consumption,” “Billing Period,” and “Cost” in an electricity bill. In a second step, the trained model 206 may determine one or more predetermined uniform categories corresponding to the identified fields. This determination is based on a field-category mapping, which serves as a reference for translating diverse field names into a standardized set of categories. For instance, the field “Total Consumption” might be mapped to the uniform category “Energy Usage,” while “Billing Period” is mapped to “Time Period,” and “Cost” is mapped to “Billing Amount.” This mapping ensures that various terms used by different service providers are uniformly interpreted and presented to the user 108.

In a third step, the trained model 206 may classify the plurality of field values associated with the identified fields into the predetermined uniform categories. This classification process involves assigning specific values from the utility bills, such as “500 kWh,” “June 2024,” and “$100,” to their respective uniform categories (“Energy Usage,” “Time Period,” and “Billing Amount”). By doing so, the system standardizes the data across all utility bills, regardless of their original terminology.

Once the classification is complete, the processor 202 may receive the uniform classified data as an output from the trained model 206. This output comprises the classified field values and their corresponding uniform categories. This standardized data can then be used to generate uniform utility reports, providing clear and comparable information across multiple utility bills for the user 108.

As an example, a user may upload multiple utility bills, say, multiple electricity bills, to the system 102. The processor 202 may identify that the trained model 206 suitable for these utility bills is a model trained specifically for electricity bills. After the generation of the bill data, the processor 202 may provide the bill data to the aforementioned identified trained model 206. The trained model 206 may first identify fields, such as “Total Consumption,” “Billing Period,” and “Cost” from each utility bill. Using the field-category mapping, the trained model 206 may determine that “Total Consumption” maps to the uniform category “Energy Usage,” “Billing Period” maps to “Time Period,” and “Cost” maps to “Billing Amount.” The trained model 206 may then classify the field values such as “500 kWh,” “June 2024,” and “INR 100” into the uniform categories. The aforesaid classified data is stored as uniform classified data. The processor 202 may receive this uniform classified data, which includes “Energy Usage: 500 kWh,” “Time Period: June 2024,” and “Billing Amount: INR 100,” and may use it for further processing represent this data in a standardized format across all utility reports for the utility bills.

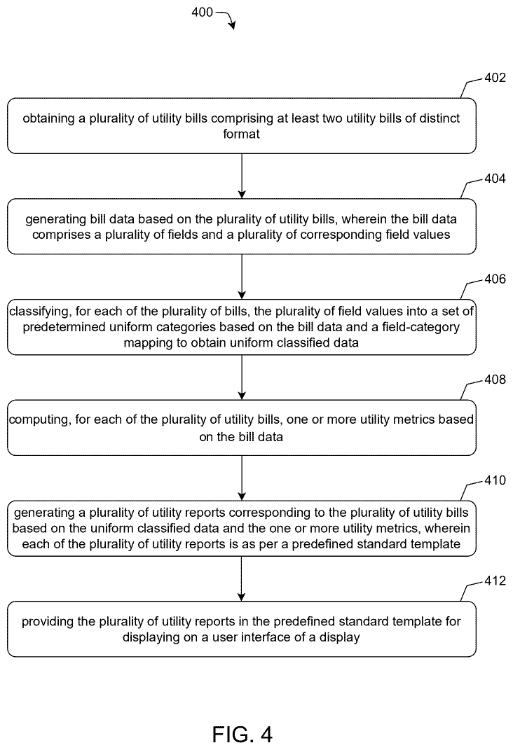

FIG. 4 illustrates a flowchart of a method 400 of processing utility bills having distinct formats, according to one or more embodiments of the present disclosure. The steps of the method 400, described in connection with the embodiments disclosed herein, may be embodied directly in hardware, in firmware, in a software module executed by the system 102, or in any practical combination thereof. In some embodiments, the method 400 may be performed at a service provider's end who is offering utility management services to enterprises. In some embodiments, the method 400 may be implemented in an enterprise for management of utility bills relating to one or more offices of the enterprise, a plurality of employees of the enterprise, one or more affiliate organizations of the enterprise, etc. By performing the method 400, a plurality of bills having distinct format are processed, and streamlined, and corresponding utility reports in a predetermined standard template are generated for viewing, say, on a dashboard of a computing device.

At step 402, the method 400 includes obtaining a plurality of utility bills comprising at least two utility bills of distinct format. Examples of the utility bills may include, but are not limited to, electricity bill, gas bill, and water consumption bill. The plurality of utility bills may be uploaded to a system, such as the system 102, implementing the method 400. The utility bills may be uploaded either as a batch file, i.e., collectively in a single package, in an example. In another example, the utility bills may be uploaded separately over a single upload session or multiple upload sessions. In some examples, an admin worker in the enterprise may upload the utility bills to the system. In some examples, a plurality of employees of the enterprise may separately upload the utility bills to the system. In some examples, a worker of the service provide may upload the utility bills to the system. In an example, the utility bills uploaded to the system may be stored in a storage associated with the system. Herein, the storage may be an internal storage of the system or may be an external storage that is communicatively coupled to the system.

In some examples, the utility bills may include at least two utility bills having distinct format. This may occur in cases where employees of the enterprise reside at different locations which are serviced by different power distribution companies. In another example, an enterprise may have offices in different states across the country. In such a case also, the different office branches may be serviced by different power distribution companies who may issue electricity bills in different formats. Accordingly, the utility bills uploaded by the admin workers of the different branch offices would be in different formats.

Without limitation, the different/distinct formats of utility bills may be understood as distinct styles of representation of various fields and corresponding field values included in a utility bill. As an example, a telecom company A may have a first format of telephone bill in which the total outstanding bill is written on a last page, a previous paid bill amount is written on a first page, and a billing cycle is written on a first page of the telephone bill. Whereas, a telecom company B may have a second format of telephone bill in which the total outstanding bill and the billing cycle is written on a first page and a previous paid bill amount is written on a last page of the telephone bill.

In some example embodiments, the utility bills may be obtained from the storage, for example, using a file path or a storage path. Herein, the storage path or the file path may indicate a location in the storage where the utility bills that are to be processed are stored. In an example, the storage path may be generated by the system at the time when the utility bills are received at the system. A unique path may be generated for each utility bill and the same may be used later during the processing for obtaining the corresponding utility bill.

At step 404, the method 400 includes generating bill data based on the plurality of utility bills. The bill data includes a plurality of fields and a plurality of corresponding field values for each of the plurality of bills. As an example, for an electricity bill, the various fields and corresponding field values may be: “Account Number: 123456789,” “Billing Period: Jun. 1, 2024-Jun. 30, 2024,” “Previous Reading: 1500 kWh,” “Current Reading: 1800 kWh,” “Usage: 300 kWh,” “Rate per kWh: INR 4,” “Total Charges: INR 10000,” “Due Date: Jul. 15, 2024,” “Payment Received: INR 5000,” and “Balance Due: INR 5000.” Accordingly, the bill data for the example electricity bill may include a bill identifier (ID), the aforementioned fields and corresponding field values. As may be understood, each of the plurality of utility bills may be processed to generate corresponding bill data. The respective bill data for each of the plurality of utility bills may be collectively referred to as the bill data. Thus, the bill data for a batch of utility bills includes corresponding bill IDs and respective fields and values.

In some embodiments, one or more techniques may be applied on the plurality of utility bills for generating the bill data. For instance, an Optical Character Recognition (OCR) technique may be applied to digitize the text in the utility bill. In some examples, a Natural Language Processing (NLP) technique may be applied for segmenting the text and for recognizing the entities in the segmented text. Furthermore, pattern matching techniques may be implemented for location and extraction of values. In some instance, where the extracted text is in a different language than a default language, a language translation technique may also be implemented for converting the language to the default language selected in the system for the processing of the utility bills. The bill data may be stored in the storage, in an example.

At step 406, the method 400 includes classifying, for each of the plurality of bills, the plurality of field values into a set of predetermined uniform categories based on the bill data and a field-category mapping to obtain uniform classified data. The predetermined uniform categories may be understood as field names defined in the system as per a defined nomenclature for a particular utility service. As an example, for telephone utility service, a company A may use a field “outstanding bill amount” to specify the bill amount to be paid for the last cycle. Another company B may use a field “bill amount due” to specify the bill amount to be paid for the last cycle. The system of the present disclosure may have a uniform category “total amount payable”, which is a field name defined in the system as per a defined nomenclature to represent the aforementioned fields used in the telephone bills. Adaptation of the uniform categories facilitates in a uniform representation of fields, thereby making it easier for users to understand the utility bills easily.

In some embodiments, the predetermined uniform categories may be generated as a part of training phase of the system 102, where one or more models are trained for processing of utility bills. Herein, different field names which represent the same field purpose are mapped to a uniform category. Thus, the model may identify each of such distinct terms and may learn to use the uniform category for these terms during the processing of the bills. Further, the various field terms may be mapped to the uniform category and may be stored as field-category mapping in the storage. As an example, in telephone bills of three companies, the amount to be paid by the users may be reflected as “outstanding bill amount”, “bill amount due”, “current charges”. According to aspects described herein, a uniform category “total amount payable” may be defined in the system. This uniform category may be mapped to the other field names used by the different companies for reflecting the amount payable by users. Accordingly, the mapping between the various field names and the uniform category may be stored in the field-category mapping.

As may be understood, a plurality of uniform categories may be defined in the system for a plurality of fields for a given utility service. Likewise, the exercise may be performed for different utility services, where for each utility service a corresponding field-category mapping is generated and stored in the storage. The system may accordingly utilize the field-category mapping applicable to the utility bills being processed based on the service sector of the utility bills.

Referring to the present step of method 400, in some embodiments, the field values may be classified into a set of predetermined uniform categories based on the field-category mapping. Herein, when a field value in a utility bill is being processed, the corresponding field is identified. Accordingly, the field-category mapping is referred and the uniform category corresponding to the field is identified from the field-category mapping. The field value is accordingly classified in the uniform category and saved as uniform classified data in the storage. Thus, at the end of the classification operation for the batch of utility bills being processed, the uniform classified data is obtained which includes the field values classified in the set of predetermined uniform categories.

At step 408, the method 400 includes computing, for each of the plurality of utility bills, one or more utility metrics based on the bill data. The utility metrics may be understood as metrics providing insights pertaining to a utility bill. For instance, for an electricity bill, the utility metrics may be overall electricity consumption, average electricity consumption, graphs illustrating consumption of electricity for a predetermined time period, say, three months. Herein, the overall electricity consumption may be computed by extracting the start meter reading and end meter reading from the bill data and calculating the difference between these readings. The average electricity consumption may be determined by dividing the overall consumption by the number of days in the billing period. Furthermore, for generating the graph, the method 400 may include aggregating the daily usage data from the bill and using this information to create visual representations like line graphs or bar charts. The utility metrics associated with a bill are stored in the storage.

At step 410, the method 400 includes generating a plurality of utility reports corresponding to the plurality of utility bills based on the uniform classified data and the one or more utility metrics. In an example, for each of the utility bills, a corresponding utility report is generated. The utility report may include the uniform categories identified for the bill during the classification operation and the utility metrics computed for the bill.

According to aspects of the present disclosure, each of the utility reports may be as per a predefined standard template. Without limitation, the term template as used herein may be understood as a structure or a layout for presenting information associated with a utility bill. In some implementations, the template may be a standard template, i.e., the various sections, sub-sections, categories within the template may be predetermined and static. In some implementations, the template may be customizable, i.e., one or more of the sections, sub-sections, and the categories may be editable/user-selectable. In said case, the user defined format for the template is used for generating the utility reports.

At step 412, the method 400 includes providing the plurality of utility reports in the predefined standard template for displaying on a user interface of a display. The utility reports in the predetermined standard template are subsequently provided to a user device for displaying to a user. Herein, the user device may have an application running in which the utility reports are presented on the dashboard.

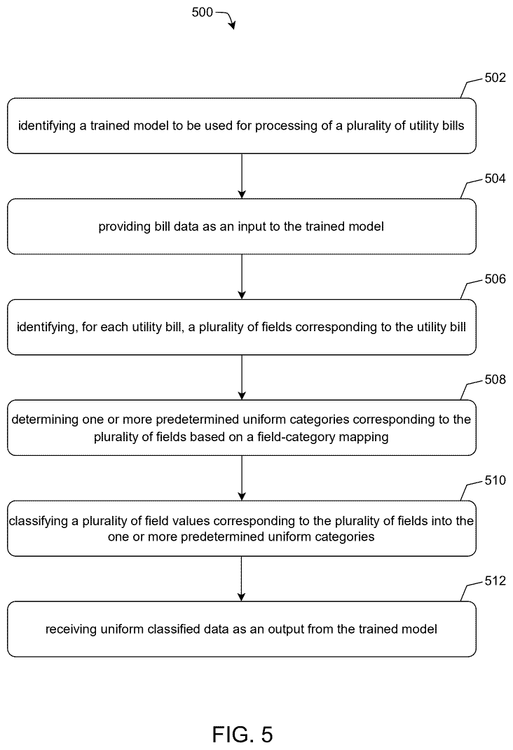

FIG. 5 illustrates a method 500 of classifying a plurality of field values of a utility bill into a set of predetermined uniform categories, according to one or more embodiments of the present disclosure. The steps of the method 500, described in connection with the embodiments disclosed herein, may be embodied directly in hardware, in firmware, in a software module executed by the system 102, or in any practical combination thereof.

At step 502, the method 500 includes identifying a trained model which is to be used for the processing of the utility bills. In an example, a system, such as the system 102, may be configured for processing a plurality of utility bills from different service providers. The plurality of utility bills may be of a same utility service and may include at least two utility bills of different format. As mentioned previously in the detailed description, the plurality of utility bills may be processed for generating bill data that is stored in the storage. The bill data includes a plurality of fields and corresponding field values, for each of the utility bills.

Once the bill data is generated, the classification operation is performed on the plurality of utility bills, for example, using a trained model. In some embodiments, the trained model may be identified based on a type of the utility service corresponding to the plurality of utility bills. For instance, a trained model A may be used for utility service A, a trained model B may be used for utility service B, and so on. The trained model may be understood as a Machine Learning (ML) based model capable of implementing one or more classification techniques and other techniques as required for the classification operation. During a training phase, a base training model may be trained using separate datasets corresponding to separate utility services to obtain respective trained models specific to the utility service types. Accordingly, during the processing of the plurality of utility bills, the trained model to be used for classification is identified based on a type of the service utility corresponding to the plurality of utility bills being processed.

In some embodiments, the trained model may be customized for the entity implementing the system 102. For instance, consider a case where a service provider is rendering utility management services to entities. Herein, the trained model for a utility service type A may be differently adapted for an enterprise A and enterprise B as per their respective inputs and preferences. In such embodiments, as and when an admin worker of the enterprise wishes to process a batch of utility bills, a bill processing request may be sent to the system 102. Without limitation, the bill processing request may include a reference or a storage path to the batch of the plurality of bills and may include an identifier associated with the trained model which was customized for the enterprise. Based on the identifier of the trained model, the trained model may accordingly be selected.

As may be understood, one or more of the aforementioned techniques or other implementation techniques may be implemented, alone or together in any combination, for the identification of the trained model.

At step 504, the method 500 includes providing the bill data as an input to the trained model. Once the training model is identified, the bill data corresponding to the plurality of utility bills being processed is provided as an input to the training model. Herein, the bill data corresponding to the plurality of utility bills may be fetched from the storage and provided as an input to the trained model along with the plurality of utility bills. As mentioned above, the bill data may include a plurality of fields and corresponding field values for each of the utility bills.

At step 506, the method 500 includes identifying, for each of the plurality of bills, a plurality of fields corresponding to the utility bill. In an example, the trained model may process each of the utility bills. The trained model may ascertain a bill ID of the utility bill being processed and accordingly, may identify the plurality of fields corresponding to the utility bill from the bill data. For instance, the trained model may analyze the bill data to identify the plurality of fields and values mapped against the bill ID. Accordingly, the trained model may identify the plurality of fields corresponding to the utility bill being processed.

As an example, on processing of an electricity bill, the trained model may first identify its bill ID, say, “001214”. Accordingly, the trained model may look for the aforementioned bill ID in the bill data. On finding the bill ID in the bill data, the trained model may identify the fields, such as account holder's name, the account number, the billing address, the billing period—showing the start and end dates for the charges being billed, the total amount due, the due date for payment, a breakdown of charges, for example, the cost per kilowatt-hour, any service fees, taxes, and any previous balance, and the total energy consumption in kilowatt-hours, corresponding to the bill ID.

At step 508, the method 500 includes determining one or more predetermined uniform categories corresponding to the plurality of fields based on a field-category mapping. Once the fields are identified, for each of the fields, a uniform category that is mapped to the field is determined. This may include accessing the field-category mapping and identifying the uniform category mapped to the field in the field-category mapping. As explained previously in the detailed description, the field-category mapping may be understood as the mapping between the various field names pertaining to a utility service and the uniform categories to which they are mapped. Thus, after accessing the field-category mapping, a query for the field may be run by the trained model to determine the uniform category corresponding to the field. Thus, in step 508, a uniform category corresponding to each field entry in a utility bill is determined. This facilitates in a uniform representation of field terms as the same nomenclature is used for utility bills from different service providers.

As an example, in telephone bills of three companies, the amount to be paid by the users may be reflected as “outstanding bill amount”, “bill amount due”, “current charges”. According to aspects described herein, a uniform category “total amount payable” may be defined as per the nomenclature of the system for being used for the three example fields and the uniform category may be stored in the field-category mappings. Thus, in the utility bill processing of these three utility bills, the uniform category “total amount payable” is determined as being corresponding to these fields, and is used for representation in the corresponding final utility reports.

At step 510, the method 500 includes classifying the plurality of field values corresponding to the plurality of fields into the one or more predetermined uniform categories. As mentioned previously in the detailed description, the uniform categories facilitate uniform representation of the field terms used by different service providers as per a defined nomenclature of the system 102. For a utility bill being processed, once all the uniform categories are determined in the previous step, the corresponding field values are classified in these uniform categories based on the field-category mapping. For instance, the trained model may take a field value of a field and check for the uniform category corresponding to the field in the field-category mapping. Once the corresponding uniform category is identified, the trained model classifies the field value in the corresponding uniform category. Once classified, the field value now mapped with the uniform category is saved as uniform classified data.

As may be understood, at the end of the processing, the uniform classified data generated by the trained model includes a plurality of uniform categories and a plurality of field values classified in the plurality of uniform categories, for each of the plurality of utility bills. Thus, a uniform representation of distinct field terms may be achieved, facilitating in easier comprehension of utility bills.

At step 512, the method 500 includes receiving uniform classified data as an output from the trained model. In an example, the uniform classified data is stored in a storage and may be used subsequently during utility report generation. In an example, the uniform classified data for each utility bill may be stored in the storage in a mapped relationship with the corresponding bill ID for the utility bill. This facilitates in easier fetching of the uniform classified data for the utility bill from the storage during the utility report generation.

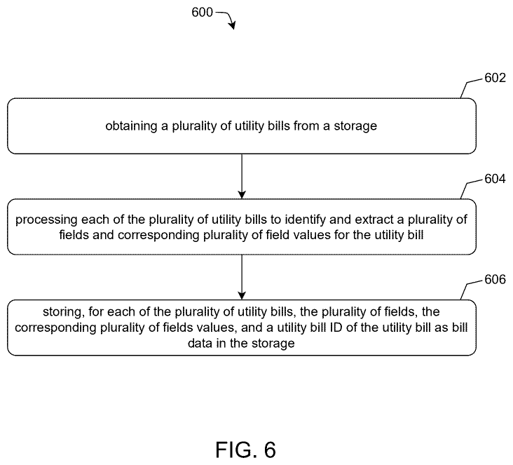

FIG. 6 illustrates a method 600 of generating bill data corresponding to a plurality of utility bills, according to one or more embodiments of the present disclosure. The steps of the method 600, described in connection with the embodiments disclosed herein, may be embodied directly in hardware, in firmware, in a software module executed by the system 102, or in any practical combination thereof.

At step 602, a plurality of utility bills is obtained from a storage. In an example, an admin worker seeking processing of the plurality of utility bills may send a bill processing request to the system using a user device. For instance, the admin worker may use an application, or a web application running on the user device and may select a storage location where the plurality of utility bills is stored. Post selection, the admin worker may be provided with an option, say, a button, for generating a bill processing request. On clicking the button, the bill processing request is generated and sent to the system. The bill processing request, amongst other things, may include a storage path corresponding to the location of the plurality of utility bills in the storage. Accordingly, based on the storage path, the plurality of utility bills is obtained from the storage for processing.

At step 604, each of the plurality of utility bills is processed to identify and extract a plurality of fields and corresponding plurality of field values for the utility bill. After obtaining the plurality of utility bills, each of the utility bill included therein may be processed. Herein, one or more techniques may be implemented for extracting data from the utility bill. For example, an OCR technique may be used for digitizing the text included in the utility bill. An entity recognition technique may be implemented for identifying the plurality of fields and corresponding field values.

In some examples, where the utility bill or a portion thereof is not in a default language of the system, a language translation technique may be implemented for converting the utility bill or a portion thereof in the default language of the system. As may be understood, other processing techniques as may be required for extracting text and recognizing the field and field values from the utility bills may be implemented.

At step 606, the plurality of fields, the corresponding plurality of fields values, and a utility bill ID of each of the plurality of utility bills is stored as bill data in the storage. The bill ID may be subsequently used during later processing of the utility bill for extracting data, such as the bill data, corresponding to the utility bill from the storage.

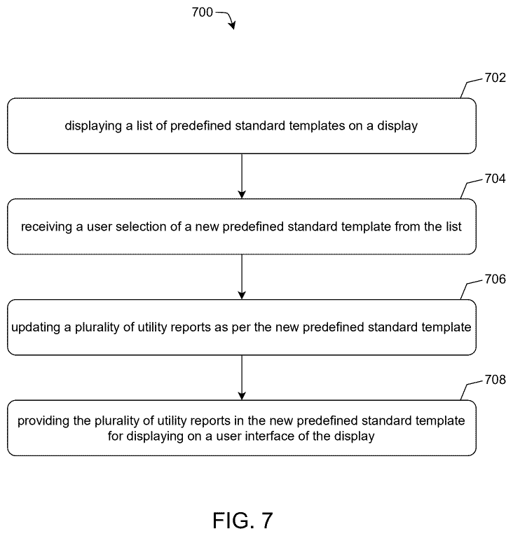

FIG. 7 illustrates a method 700 of updating a plurality of utility reports as per a template selected by a user, according to one or more embodiments of the present disclosure. The steps of the method 700, described in connection with the embodiments disclosed herein, may be embodied directly in hardware, in firmware, in a software module executed by the system 102, or in any practical combination thereof.

At step 702, a list of predefined standard templates is displayed on a display. In an example, a user may seek to update a format in which a plurality of utility reports corresponding to the plurality of utility bills is presented. For instance, in a template A, the outstanding bill amount may be presented on a second page, however, the user may seek to have it displayed on the first page. Accordingly, the user may seek to update the format in which the outstanding bill amount is displayed on the first page. The user may access an application or a web application where the utility reports are displayed to the user and may select an option for selecting report formats. On clicking the option, the list of predefined standard templates may be presented to the user on the display.

At step 704, a user selection of a new predefined standard template from the list is received. As used herein, the new predefined standard template may be understood as a predefined standard template different from the predefined standard template in which the plurality of utility reports was generated. As mentioned in the above example, the user may seek a utility report format in which the outstanding bill amount is displayed on the first page. Accordingly, from the list of predefined standard templates displayed to the user, the user may select the predefined standard template in which the outstanding bill amount is displayed in the first page.

At step 706, a plurality of utility reports is updated as per the new predefined standard template. Herein, each of the utility reports is converted into a format of the predefined standard template selected by the user in step 704. Accordingly, in the example, the outstanding bill amount is now displayed on the first page in all the utility reports.

At step 708, the plurality of utility reports in the new predefined standard template are provided for displaying on a user interface of the display. In an example, the updated utility reports are provided on the user interface of the application or the web application. For instance, the user interface may be of a dashboard running on the application or the web application and the utility reports may be displayed thereon. As may be understood, the utility reports may be displayed one at a time, with an option provided to the user for selecting a next utility report and a previous utility report.

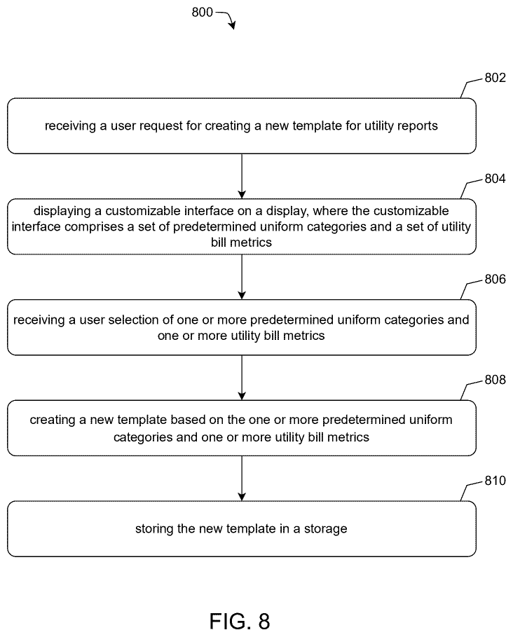

FIG. 8 illustrates a method 800 of creating a new template for utility reports, according to one or more embodiments of the present disclosure. The steps of the method 800, described in connection with the embodiments disclosed herein, may be embodied directly in hardware, in firmware, in a software module executed by the system 102, or in any practical combination thereof.

At step 802, a user request for creating a new template for utility reports is received from a user. In an example, a user may seek to create the new template for defining a format for the utility reports as per his viewing preference. Accordingly, the user may select a corresponding option on an application or a web application running on a user device. Once the option is selected, the user request is sent from the user device to the system.

At step 804, a customizable interface is displayed on a display. In response to receiving the user request for creating a new template, the customizable interface is displayed on the display. The interface may be displayed in the application or web application of the user device. As mentioned previously in the detailed description, the utility reports include a plurality of uniform categories and one or more metrics. Thus, for editing the template of the utility report, the customizable interface may include a set of predetermined uniform categories and a set of utility metrics.

In some examples, the customizable interface may provide the user with one or more options to select or drop one or more uniform categories from the template of the utility report. For instance, some default uniform categories, such as a bill ID, may be made non-selectable while other uniform categories may be made selectable/available for dropping. In some examples, the customizable interface may provide the user with options to select or drop all of the uniform categories from the template of the utility report. In some examples, the customizable interface may provide the user with options to select or drop one or more utility metrics from the template of the utility report. In some examples, the customizable interface may provide the user with options to select or drop all of the utility metrics from the template of the utility report.

In some examples, the customizable interface may provide the user with one or more options to change a size of the area in which a uniform category is displayed in the template of the utility report. In some examples, the customizable interface may provide the user with one or more options to change a size of the area in which a group of uniform categories is displayed in the template of the utility report. In some examples, the customizable interface may provide the user with one or more options to change a size of the area in which a utility metric is displayed in the template of the utility report. In some examples, the customizable interface may provide the user with one or more options to change a size of the area in which a group of utility metrics is displayed in the template of the utility report.

At step 806, a user selection of one or more predetermined uniform categories and one or more utility metrics is received from the user. Herein, the selection may be understood as the action of selecting the one or more uniform categories and the one or more utility metrics. Furthermore, the term selection may also include user actions for adjusting a size of the area pertaining to the one or more uniform categories and the one or more utility metrics. Accordingly, based on the user selection, the finalized uniform categories and the utility metrics that are to be included in the utility report template are determined.

At step 808, the new template is created based on the one or more predetermined uniform categories and the one or more utility metrics. The selected uniform categories and the utility metrics are used for creating the new template.

At step 810, in an example, the new template may be stored in the storage and may be added to a list of predefined template, say, as user template 1. The user may accordingly select the template for updating/generating the report in the user created template.

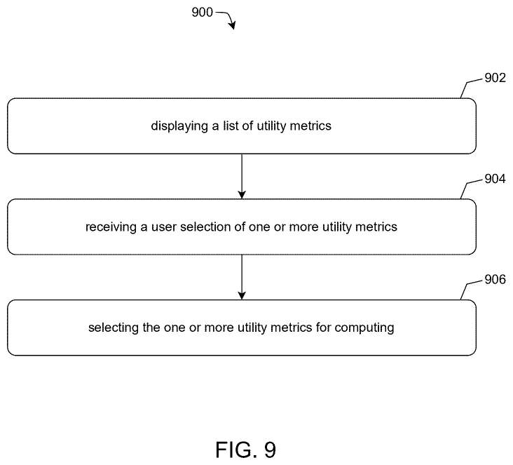

FIG. 9 illustrates a method 900 of selecting utility metrics for utility reports, according to one or more embodiments of the present disclosure. The steps of the method 900, described in connection with the embodiments disclosed herein, may be embodied directly in hardware, in firmware, in a software module executed by the system 102, or in any practical combination thereof.

At step 902, a list of utility metrics is displayed. As mentioned previously in the detailed description, the utility metrics may be understood as metrics providing insights pertaining to a utility bill. For instance, for an electricity bill, the utility metrics may be overall electricity consumption, average electricity consumption, graphs illustrating consumption of electricity for a predetermined time period, say, three months.

In some embodiments, a list of utility metrics may be displayed to a user on a display of a user device. For instance, the list including the utility metrics may be displayed on a desktop computer of an admin worker of an enterprise who is seeking processing of a plurality of bills. In an example, the list of the utility metrics may be displayed to the user in response to receiving of a bill processing request received from the user device. By receiving the user selection of the utility metrics in advance, the utility reports corresponding to the utility bills are generated accordingly to include the utility metrics desired by the user. In some examples, an option, such as a button, for selecting the utility metrics may be provided on a dashboard running on the user device on which the utility reports are displayed. The user may at any time select the option for selecting the utility metrics that the user desires to see in the utility reports. Accordingly, in response to selection of the button, the list of the utility metrics may be displayed on the user device.

In some examples, the list of utility metrics may be adaptable. For instance, the list may be intelligently modified by the system 102 based on the available data. Herein, the possible utility metrics that may be calculated as per the available data are determined and accordingly made available for display on the user device. Thus, the display of the list of utility metrics may be done intelligently. For instance, first, the data may be analysed by the system 102 and thereafter the list may be made available for displaying on the user device.

At step 904, a user selection of one or more utility metrics is received. In an example, the list of the utility metrics may include a corresponding checkbox against each utility metric listed in the list. Accordingly, the user may check or uncheck the checkbox as desired. Once the one or more utility metrics are selected by the user, the user may click on a button, such as ‘submit’ or ‘next’ or ‘OK’ that is being displayed along with the list. On receiving the click input, the user selection of the one or more utility metrics is received by the system.

At step 906, the one or more utility metrics are selected for computing. From the received selection, the user selected one or more utility metrics are identified. Accordingly, these identified utility metrics are selected for computing operation stage during the processing of the utility bills. As and when the computing operation stage is triggered, the utility metrics are computed for each of the utility bills and included in the utility report as per the template of the utility report. The utility metrics are accordingly viewable by the user in the utility reports.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A system for processing utility bills having distinct formats, wherein the system comprises:
a storage;
at least one processor coupled to the storage, wherein the at least one processor is configured to:
obtain a plurality of utility bills comprising at least two utility bills of distinct format;
generate bill data based on the plurality of utility bills, wherein the bill data comprises a plurality of fields and a plurality of corresponding field values for each of the plurality of bills;
classify, for each of the plurality of bills, the plurality of field values into a set of predetermined uniform categories based on the bill data and a field-category mapping to obtain uniform classified data, wherein the field-category mapping comprises the plurality of fields in a mapped relationship with the set of predetermined uniform categories;
compute, for each of the plurality of utility bills, one or more utility metrics based on the bill data;
generate a plurality of utility reports corresponding to the plurality of utility bills based on the uniform classified data and the one or more utility metrics, wherein each of the plurality of utility reports is as per a predefined standard template, and wherein each of the plurality of utility reports comprises the one or more utility metrics and the uniform classified data for the corresponding utility bill in the predefined standard template; and
provide the plurality of utility reports in the predefined standard template for displaying on a user interface of a display.

2. The system of claim 1, wherein for classifying the plurality of field values into the set of predetermined uniform categories to obtain the uniform classified data, the at least one processor is further configured to:
identify a trained model which is to be used for the processing of the utility bills;
provide the bill data as an input to the trained model, wherein the trained model performs the steps of:
identifying, for each of the plurality of bills, the plurality of fields corresponding to the utility bill;
determining one or more predetermined uniform categories corresponding to the plurality of fields based on the field-category mapping; and
classifying the plurality of field values corresponding to the plurality of fields into the one or more predetermined uniform categories; and
receive the uniform classified data as an output from the trained model, the uniform classified data comprising the classified plurality of field values and the corresponding one or more predetermined uniform categories.

3. The system of claim 1, wherein for generating the bill data, the at least one processor is further configured to:
obtain, using a storage path, the plurality of utility bills from the storage;
process, each of the plurality of utility bills, to identify and extract the plurality of fields and corresponding plurality of field values; and
store the plurality of fields, the corresponding plurality of fields values, and a utility bill ID of the utility bill as the bill data in the storage.

4. The system of claim 3, wherein the at least one processor is further configured to, convert the plurality of fields and corresponding field values into a default language selected for the utility report.

5. The system of claim 1, wherein the at least one processor is further configured to:
display a list of predefined standard templates on the display;
receive a user selection of a new predefined standard template from the list, wherein the new predefined standard template is a predefined standard template different than the predefined standard template in which the plurality of utility reports was generated;
update the plurality of utility reports as per the new predefined standard template; and
provide the plurality of utility reports in the new predefined standard template for displaying on the user interface of the display.

6. The system of claim 1, wherein the at least one processor is further configured to:
receive a user request for creating a new template for utility reports;
display a customizable interface on the display, wherein the customizable interface comprises the set of predetermined uniform categories and a set of utility metrics;
receive a user selection of one or more predetermined uniform categories and one or more utility metrics;
create the custom template based on the one or more predetermined uniform categories and one or more utility metrics; and
store the custom template in a storage.

7. The system of claim 1, wherein the at least one processor is further configured to:
display a list of utility metrics; and
receive a user selection of the one or more utility metrics; and
select the one or more utility metrics for computing.

8. A method of processing utility bills having distinct formats, wherein the method comprises:
obtaining, by a processor, a plurality of utility bills comprising at least two utility bills of distinct format;
generating bill data based on the plurality of utility bills, wherein the bill data comprises a plurality of fields and a plurality of corresponding field values for each of the plurality of bills;
classifying, for each of the plurality of bills, the plurality of field values into a set of predetermined uniform categories based on the bill data and a field-category mapping to obtain uniform classified data, wherein the field-category mapping comprises the plurality of fields in a mapped relationship with the set of predetermined uniform categories;
computing, for each of the plurality of utility bills, one or more utility metrics based on the bill data;
generating a plurality of utility reports corresponding to the plurality of utility bills based on the uniform classified data and the one or more utility metrics, wherein each of the plurality of utility reports is as per a predefined standard template, and wherein each of the plurality of utility reports comprises the one or more utility metrics and the uniform classified data for the corresponding utility bill in the predefined standard template; and
providing the plurality of utility reports in the predefined standard template for displaying on a user interface of a display.

9. The method of claim 8, wherein the classifying further comprises:
identifying a trained model which is to be used for the processing of the utility bills;
providing the bill data as an input to the trained model, wherein the trained model performs the steps of:
identifying, for each of the plurality of bills, the plurality of fields corresponding to the utility bill;
determining one or more predetermined uniform categories corresponding to the plurality of fields based on the field-category mapping; and
classifying the plurality of field values corresponding to the plurality of fields into the one or more predetermined uniform categories;
receiving the uniform classified data as an output from the trained model, the uniform classified data comprising the classified plurality of field values and the corresponding one or more predetermined uniform categories.

10. The method of claim 8, wherein the generating the bill data further comprises:
obtaining, using a storage path, the plurality of utility bills from a storage;
processing each of the plurality of utility bills to identify and extract the plurality of fields and corresponding plurality of field values for the utility bill; and
storing, for each of the plurality of utility bills, the plurality of fields, the corresponding plurality of fields values, and a utility bill ID of the utility bill as the bill data in the storage.

11. The method of claim 10, wherein the method further comprises, converting the plurality of fields and corresponding field values into a default language selected for the utility report.

12. The method of claim 8, further comprising:
displaying a list of predefined standard templates on the display;
receiving a user selection of a new predefined standard template from the list, wherein the new predefined standard template is a predefined standard template different than the predefined standard template in which the plurality of utility reports was generated;
updating the plurality of utility reports as per the new predefined standard template; and
providing the plurality of utility reports in the new predefined standard template for displaying on the user interface of the display.

13. The method of claim 8, further comprising:
receiving a user request for creating a new template for utility reports;
displaying a customizable interface on the display, wherein the customizable interface comprises the set of predetermined uniform categories and a set of utility metrics;
receiving a user selection of one or more predetermined uniform categories and one or more utility metrics;
creating the new template based on the one or more predetermined uniform categories and one or more utility metrics; and
storing the new template in a storage.

14. The method of claim 8, wherein the method further comprises:
displaying a list of utility metrics; and
receiving a user selection of the one or more utility metrics; and
selecting the one or more utility metrics for computing.

15. A computer-readable medium having computer-executable instructions stored thereon that, when executed by a processing system, cause the processing system to:
obtain a plurality of utility bills comprising at least two utility bills of distinct format;
generate bill data based on the plurality of utility bills, wherein the bill data comprises a plurality of fields and a plurality of corresponding field values for each of the plurality of bills;
classify, for each of the plurality of bills, the plurality of field values into a set of predetermined uniform categories based on the bill data and a field-category mapping to obtain uniform classified data, wherein the field-category mapping comprises the plurality of fields in a mapped relationship with the set of predetermined uniform categories;
compute, for each of the plurality of utility bills, one or more utility metrics based on the bill data;
generate a plurality of utility reports corresponding to the plurality of utility bills based on the uniform classified data and the one or more utility metrics, wherein each of the plurality of utility reports is as per a predefined standard template, and wherein each of the plurality of utility reports comprises the one or more utility metrics and the uniform classified data for the corresponding utility bill in the predefined standard template; and
provide the plurality of utility reports in the predefined standard template for displaying on a user interface of a display.

16. The computer-readable medium of claim 15, wherein the computer-executable instructions cause the processing system to:
identify a trained model which is to be used for the processing of the utility bills;
provide the bill data as an input to the trained model, wherein the trained model performs the steps of:
identifying, for each of the plurality of bills, the plurality of fields corresponding to the utility bill;
determining one or more predetermined uniform categories corresponding to the plurality of fields based on the field-category mapping; and
classifying the plurality of field values corresponding to the plurality of fields into the one or more predetermined uniform categories; and
receive the uniform classified data as an output from the trained model, the uniform classified data comprising the classified plurality of field values and the corresponding one or more predetermined uniform categories.

17. The computer-readable medium of claim 16, wherein the computer-executable instructions cause the processing system to:
obtain, using a storage path, the plurality of utility bills from a storage;
process, each of the plurality of utility bills, to identify and extract the plurality of fields and corresponding plurality of field values; and
store the plurality of fields, the corresponding plurality of fields values, and a utility bill ID of the utility bill as the bill data in the storage.

18. The computer-readable medium of claim 15, wherein the computer-executable instructions cause the processing system to:
convert the plurality of fields and corresponding field values into a default language selected for the utility report.

19. The computer-readable medium of claim 15, wherein the computer-executable instructions cause the processing system to:
display a list of predefined standard templates on the display;
receive a user selection of a new predefined standard template from the list, wherein the new predefined standard template is a predefined standard template different than the predefined standard template in which the plurality of utility reports was generated;
update the plurality of utility reports as per the new predefined standard template; and
provide the plurality of utility reports in the new predefined standard template for displaying on the user interface of the display.

20. The computer-readable medium of claim 15, wherein the computer-executable instructions cause the processing system to:
receive a user request for creating a new template for utility reports;
display a customizable interface on the display, wherein the customizable interface comprises the set of predetermined uniform categories and a set of utility metrics;
receive a user selection of one or more predetermined uniform categories and one or more utility metrics;
create the custom template based on the one or more predetermined uniform categories and one or more utility metrics; and
store the custom template in a storage.
